(19) United States
(12) Patent Application Publication
(10) Pub. No.: US 2014/0050107 A1
(43) Pub. Date: Feb. 20, 2014

(54) ERROR PREVENTION IN DYNAMIC UPLINK/DOWNLINK CONFIGURATION CHANGE FOR TIME DIVISION DUPLEX

(71) Applicant: RENESAS MOBILE CORPORATION, Tokyo (JP)

(72) Inventors: Gilles CHARBIT, Farnborough (GB); Chunyan GAO, Beijing (CN); Erlin ZENG, Beijing (CN)

(73) Assignee: RENESAS MOBILE CORPORATION, Tokyo (JP)

(21) Appl. No.: 14/058,664

(22) Filed: Oct. 21, 2013

Related U.S. Application Data
(63) Continuation of application No. PCT/CN2011/073117, filed on Apr. 21, 2011.

(51) Int. Cl. H04W 72/12; H04W 24/02; H04L 1/00

(52) U.S. Cl. CPC H04W 72/1289; H04L 1/0002; H04W 24/02
USPC 370/252

(57) ABSTRACT

Method and apparatus which prevents or at least significantly reduces errors during dynamic TDD UL/DL configuration changes. Received downlink time division duplex subframes are monitored during a predetermined time window, wherein at least a portion of the subframes includes an uplink/downlink configuration indication. In response to not detecting an uplink/downlink configuration indicated by any of the uplink/downlink configuration indications in the monitored downlink time division duplex subframes, an average of the monitored uplink/downlink configuration indications is calculated. The calculated average is utilized in determining a time division duplex uplink/downlink configuration to be used.

### CROSS REFERENCE TO RELATED APPLICATION

This application is a Continuation of PCT International Patent Application No. PCT/CN2011/073117 filed on Apr. 21, 2011, the entire content of which is incorporated herein by reference.

### BACKGROUND INFORMATION

1. Field of the Invention

The invention relates generally to mobile communications. In particular, the invention relates to methods, computer programs, apparatuses and radio network nodes for error prevention during dynamic uplink/downlink configuration changes for time division duplex.

2. Description of the Related Art

Long Term Evolution (LTE) was introduced in release 8 of 3^{rd} Generation Partnership Project (3GPP) which is a specification for 3^{rd} generation mobile communication systems. LTE is a technique for mobile data transmission that aims to increase data transmission rates and decrease delays, among other things. LTE uses orthogonal frequency division multiple access (OFDMA) as its multiple access method in the downlink. The uplink uses single-carrier frequency division multiple access (SD-FDMA). 3GPP release 10 introduced a next version of LTE, named LTE Advanced, fulfilling 4^{th} generation system requirements.

Both LTE and LTE Advanced may utilize a technique called time division duplex (TDD) for separating the transmission directions from the user to the base station and back. In TDD mode, the downlink and the uplink are on the same frequency and the separation occurs in the time domain, so that each direction in a call is assigned to specific timeslots.

Herein, the term “downlink” (DL) is used to refer to the link from the base station to the mobile device or user equipment, and the term “uplink” (UL) is used to refer to the link from the mobile device or user equipment to the base station.

FIG. 1 illustrates the frame structure for LTE TDD. The uplink and downlink for LTE TDD are divided into radio frames 100, each of which is 10 ms in length. The radio frame 400 consists of two half-frames 111, 112, both of which are 5 ms long. The first half-frame 111 is further split into five subframes 120-124, each 1 ms long. Similarly, the second half-frame 112 is further split into five subframes 125-129, each 1 ms long. Subframes 120, 122-125, and 127-129 are reserved for either downlink or uplink data, whereas subframes 121 and 126 are so called “special” subframes that include three special fields: downlink pilot time slot (DwPTS), guard period (GP) and uplink pilot time slot (UpPTS). However, as discussed below, in some configurations subframe 126 may also be reserved for downlink data, with the subframe 121 being the only special subframe. All non-special subframes consist of two time slots, both 0.5 ms long.

TDD allows asymmetry of the uplink and downlink data rates, i.e. as the amount of uplink or downlink data increases, more communication capacity can be allocated, and as the traffic load becomes lighter, capacity can be taken away.

This asymmetry is implemented via seven different semi-static uplink-downlink configurations, illustrated below in Table 1:

TABLE 1

| Uplink/downlink | Subframe number | | | | | | | | | |
|---|---|---|---|---|---|---|---|---|---|---|
| configuration | 0 | 1 | 2 | 3 | 4 | 5 | 6 | 7 | 8 | 9 |
| 0 | D | S | U | U | U | D | S | U | U | U |
| 1 | D | S | U | U | D | D | S | U | U | D |
| 2 | D | S | U | D | D | D | S | U | D | D |
| 3 | D | S | U | U | U | D | D | D | D | D |
| 4 | D | S | U | U | D | D | D | D | D | D |
| 5 | D | S | U | D | D | D | D | D | D | D |
| 6 | D | S | U | U | U | D | S | U | U | D |

In Table 1, “D” indicates that downlink data is transmitted in this subframe, “U” indicates that uplink data is transmitted in this subframe, and “S” indicates that the special fields DwPTS, GP and UpPTS are transmitted in this subframe. As can be seen, the seven different uplink/downlink configurations 0-6 contain different ratios of uplink and downlink data, and allow asymmetric uplink and downlink data rates.

Furthermore, in all seven configurations 0-6 subframes 0 and 5 are always for downlink, subframe 1 is always a special subframe, subframe 2 is always for uplink, and subframe 6 is a special subframe or for downlink. In other words, no matter which uplink-downlink configuration is applied, there are always subframes with fixed link direction.

Herein, such subframes with fixed link direction are referred to as fixed subframes. Subframes with non-fixed link direction are herein referred to as non-fixed subframes.

The above prior art uplink-downlink configurations can provide between 40% and 90% DL subframes. A current mechanism for changing from one uplink-downlink configuration to another is based on a system information exchange procedure.

However, since system information is sent at the interval of at least 640 ms, it cannot provide dynamic TDD configuration to adapt to an instantaneous traffic situation.

For example, in 3GPP Release 8, the TDD configuration may be semi-statically changed via system information update through SIB-1 (system information block, SIB). The Broadcast Control Channel (BCCH) notification period is equal to modificationPeriodCoeff*defaultPagingCycle in radio frames, with modificationPeriodCoeff being 1, 2, . . . , 8 and defaultPagingCycle being 32, 64, 128, 256. Hence, the minimum notification period is 1×32=32 radio frames or approximately 0.32 seconds. The maximum notification period is 8×256=32 radio frames or approximately 20.48 s. If the TDD configuration is changed dynamically and faster than what is provided in 3GPP specifications, how can the user equipment (UE) know the new TDD configuration?

One way is to use radio resource control (RRC) signalling to semi-statically change the TDD configuration. This can be faster and more flexible than the way provided in 3GPP specifications (i.e. based on system information update via SIB-1). RRC signaling is dedicated signaling. Assuming there are N UEs, then the overhead for TDD reconfiguration will increase linearly with the value of N. An advantage of the RRC signaling is that the UE can acknowledge the new TDD configuration during the RRC signaling exchange.

However, the above procedure doesn't prevent possible errors at the UE side or the eNB side (i.e. RRC signaling failing due to serious DL or UL coverage issues).

As a result, a few “rogue” UEs which didn't get the new TDD configuration may continue their operations under the old TDD configuration assumption. In particular, they may make CRS-based (cell-specific reference signal, CRS) measurements during UL subframes assuming them to be DL subframes. This will bias the measurements and corrupt handover mechanisms when these UEs have their first opportunity to report these measurements—assuming that they will eventually get the right TDD configuration so that normal LTE TDD operations may resume. Both the eNB and “rogue” UEs may have no way to know that errors were made.

Prior art also includes indicating the TDD UL/DL configuration implicitly via a scheduling grant. However, the problem with this is that if there is no scheduling grant for a given UE, the UE will never know the link direction of the non-fixed subframes. Therefore, it cannot use these subframes for RRM measurement, CQI measurement, or filtering for channel estimation. In practice, the CQI in the non-fixed subframes may be quite different from that in the fixed subframes, due to e.g. different interference levels. Thus, enabling UE's CQI measurement in non-fixed subframes may provide the network side relevant information for better resource scheduling. Moreover, the UE has to monitor the non-fixed subframes for PDCCH before knowing if it is DL or UL, and this increases the UE's power consumption. Yet another problem is on the HARQ timing: if there is no scheduling grant for a given non-fixed subframe, the UE will not be aware of the real TDD UL/DL configuration. Therefore, it cannot use the TDD UL/DL configuration dependent HARQ timing as specified in Release 10.

Therefore, an object of the present invention is to alleviate the problems described above and to introduce a solution that allows preventing or at least significantly reducing errors during dynamic TDD UL/DL configuration changes.

### SUMMARY

A first aspect of the present invention is a method in which received downlink time division duplex subframes of wireless data transmission are monitored during a predetermined time window, wherein at least a portion of the subframes includes an uplink/downlink configuration indication. In response to not detecting an uplink/downlink configuration indicated by any of the uplink/downlink configuration indications in the monitored downlink time division duplex subframes, an average of the monitored uplink/downlink configuration indications is calculated. The calculated average is utilized in determining a time division duplex uplink/downlink configuration to be used.

A second aspect of the present invention is an apparatus which includes a monitoring unit that is configured to monitor received downlink time division duplex subframes of wireless data transmission during a predetermined time window, at least a portion of the subframes including an uplink/downlink configuration indication; an averaging unit that is configured to calculate an average of the monitored uplink/downlink configuration indications in response to not detecting an uplink/downlink configuration indicated by any of the uplink/downlink configuration indications in the monitored downlink time division duplex subframes; and a time division duplex uplink/downlink configuration determination unit that is configured to utilize the calculated average in determining a time division duplex uplink/downlink configuration to be used.

A third aspect of the present invention is a computer program including code adapted to cause the following when executed on a data-processing system:

monitoring received downlink time division duplex subframes of wireless data transmission during a predetermined time window, at least a portion of the subframes including an uplink/downlink configuration indication;

in response to not detecting an uplink/downlink configuration indicated by any of the uplink/downlink configuration indications in the monitored downlink time division duplex subframes, calculating an average of the monitored uplink/downlink configuration indications; and

utilizing the calculated average in determining a time division duplex uplink/downlink configuration to be used.

A fourth aspect of the present invention is an apparatus which includes a monitoring means for monitoring received downlink time division duplex subframes of wireless data transmission during a predetermined time window, at least a portion of the subframes including an uplink/downlink configuration indication; an averaging means for calculating an average of the monitored uplink/downlink configuration indications in response to not detecting an uplink/downlink configuration indicated by any of the uplink/downlink configuration indications in the monitored downlink time division duplex subframes; and a time division duplex uplink/downlink configuration determination means for utilizing the calculated average in determining a time division duplex uplink/downlink configuration to be used.

In an embodiment of the invention, in response to detecting an uplink/downlink configuration indicated by an uplink/downlink configuration indication in a monitored downlink time division duplex subframe, the monitoring is stopped for subsequent subframes in the remaining time window; and the detected uplink/downlink configuration is utilized in determining a time division duplex uplink/downlink configuration to be used.

In an embodiment of the invention, the received subframes include fixed subframes.

In an embodiment of the invention, information about the predetermined time window is obtained from a received indication of the predetermined time window.

In an embodiment of the invention, in response to determining the time division duplex uplink/downlink configuration to be used, an acknowledgement is sent to a sender of the uplink/downlink configuration indications.

In an embodiment of the invention, the acknowledgement includes a bit to be sent via a physical uplink control channel by triggering a scheduling request on configured physical uplink control channel resources.

In an embodiment of the invention, scheduling request transmission periodicity and scheduling request subframe offset are aligned with an uplink/downlink configuration change periodicity.

In an embodiment of the invention, the scheduling request is appended at the end of a sequence of concatenated hybrid automatic repeat request acknowledgement information bits in response to the transmission of the scheduling request coinciding in time with transmission of hybrid automatic repeat request acknowledgement feedback using physical uplink control channel format 3.

In an embodiment of the invention, physical uplink control channel format 1 is utilized in transmitting the scheduling request.

In an embodiment of the invention, at least one of the uplink/downlink configuration indications includes a component carrier applicability indication.

In an embodiment of the invention, the computer program of the third aspect of the present invention is stored on a computer readable medium.

It is to be understood that the aspects and embodiments of the invention described above may be used in any combination with each other. Several of the aspects and embodiments may be combined together to form a further embodiment of the invention. A method, an apparatus, or a computer program which is an aspect of the invention may include at least one of the embodiments of the invention described above.

The invention allows preventing or at least significantly reducing errors during dynamic TDD UL/DL configuration changes.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a diagram illustrating the frame structure for time division duplex;

FIG. 2 is a flow diagram illustrating a method according to an embodiment of the invention; and

FIG. 3 is a block diagram illustrating an apparatus according to an embodiment of the invention.

### DETAILED DESCRIPTION OF THE PREFERRED EMBODIMENTS

Reference will now be made in detail to the embodiments of the invention, examples of which are illustrated in the accompanying drawings.

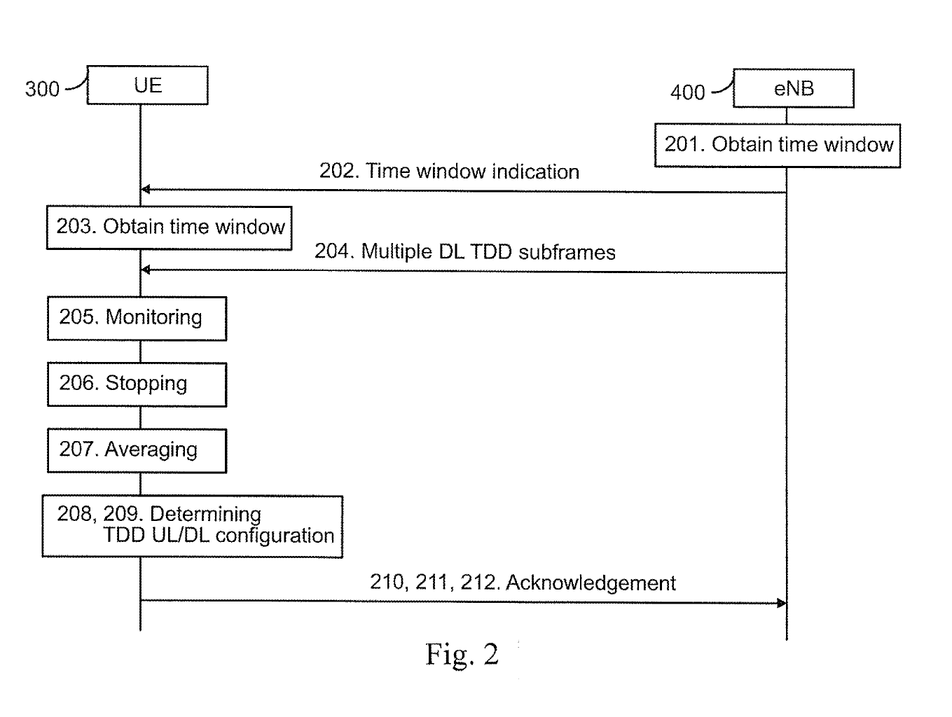

FIG. 2 is a flow diagram illustrating a method of preventing errors during dynamic TDD UL/DL configuration changes according to an embodiment of the invention.

At step 201, a radio network node 400 obtains a time window for monitoring of time division duplex (TDD) uplink/downlink (UL/DL) configuration changes. The radio network node 400 may include e.g. a base station or an evolved Node B (eNB). The radio network node 400 may be deployed e.g. in a mobile communications network utilizing a version of LTE technology, such as LTE Advanced, for example.

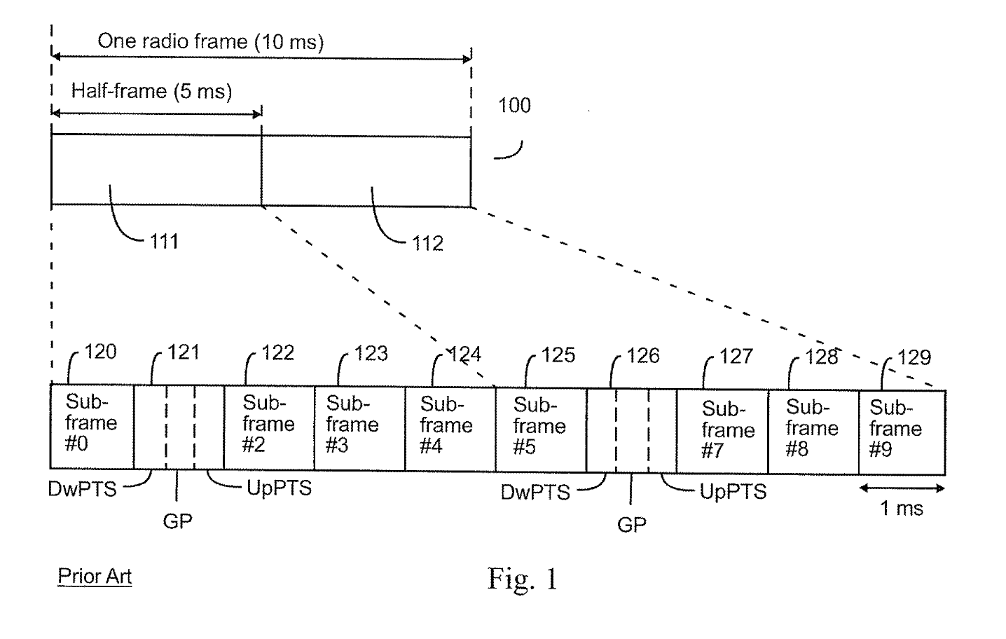

The TDD UL/DL configuration changes are indicated via TDD UL/DL configuration indications or signalings that are used to indicate which non-fixed subframes of a TDD radio frame (illustrated in FIG. 1) are allocated for downlink use and which are allocated for uplink use. These TDD UL/DL configuration indications or signalings may be e.g. such as those described in an earlier application PCT/CN2011/071120 by the present applicant (e.g. a DCI (downlink control information) format using PCFICH-like (physical control format indicator channel) or PHICH-like (physical hybrid ARQ indicator channel) modulation formats), or other suitable TDD UL/DL configuration indications or signaling known to a person skilled in the art.

At step 202, an indication of the obtained time window is transmitted from the radio network node 400 to the apparatus 300. At step 203, the apparatus 300 obtains information about the time window based on the received indication.

The time window may be indicated to the apparatus 300 via a higher layer.

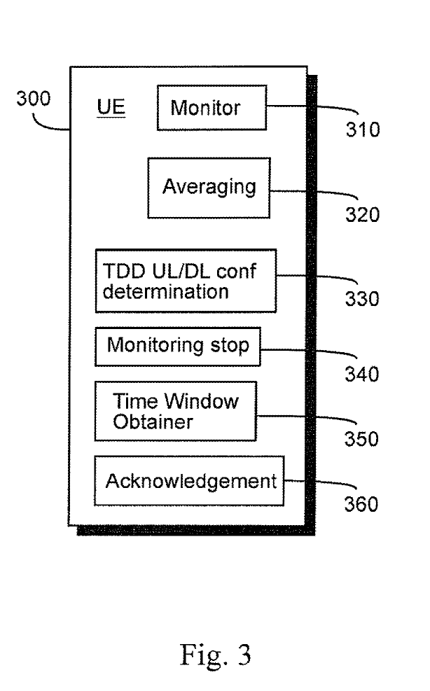

As discussed in more detail with reference to FIG. 3, the apparatus 300 may include e.g. a mobile device or a handset or a user equipment (UE) of a mobile communications network. Alternatively, the apparatus 300 may include e.g. a chipset deployed in a mobile device or a handset or a user equipment of a mobile communications network.

At step 204, the radio network node 400 transmits multiple downlink (DL) time division duplex (TDD) subframes of wireless data during the predetermined or obtained time window, with at least a portion of the subframes including a TDD UL/DL configuration indication or signaling, as described above. For example, a same UL/DL TDD configuration can be sent from the radio network node 400 on the TDD UL/DL configuration indication in any of N fixed DL subframes in the predefined time window.

At step 205, the apparatus 300 monitors received downlink time division duplex subframes of the wireless data transmission it receives during the time window.

At step 207, in response to the apparatus 300 not detecting an uplink/downlink configuration indicated by any of the uplink/downlink configuration indications in the monitored downlink time division duplex subframes, the apparatus 300 calculates an average of the monitored uplink/downlink configuration indications. Then, at step 208, the calculated average is utilized in determining a time division duplex uplink/downlink configuration to be used.

Alternatively, at step 206, in response to the apparatus 300 detecting an uplink/downlink configuration indicated by an uplink/downlink configuration indication in a monitored downlink time division duplex subframe, the apparatus 300 stops the monitoring for subsequent subframes in the remaining time window; and the detected uplink/downlink configuration is utilized in determining a time division duplex uplink/downlink configuration to be used, step 209.

For example, if the apparatus 300 detects one TDD configuration on TDD UL/DL configuration indication S_{TDD}_{_{—}}_{CONFIG,n} in one fixed subframe FSₙ, in the time window, T_{TDD}_{_{—}}_{CONFIG}, it can stop monitoring it in the following subframes in the time window to save power. Otherwise it can buffer the received signal, S_{TDD}_{_{—}}_{CONFIG,n}, in the fixed subframe FSₙ, receive the next signal S_{TDD}_{_{—}}_{CONFIG,n+1} in one fixed subframe, FSₙ₊₁, and average it with the other S_{TDD}_{_{—}}_{CONFIG,n}, . . . , S_{TDD}_{_{—}}_{CONFIG,2}, S_{TDD}_{_{—}}_{CONFIG,1} in the previous fixed subframes FSₙ, . . . , FS₂, FS₁ within the configured time window T_{TDD}_{_{—}}_{CONFIG}. This allows averaging over a maximum of N repetitions of the signal S_{TDD}_{_{—}}_{CONFIG} over T_{TDD}_{_{—}}_{CONFIG}.

An advantage of the invention is that, though the radio network node 400 can choose a practical number of control channel elements (CCE) for the TDD configuration indication bits to give high protection via Frequency Diversity (i.e. aggregation level, search space complexity), the time window of the present invention can further improve the performance via Time Diversity (i.e. it allows averaging of deep fade over many repeated transmission of the new signaling S_{TDD}_{_{—}}_{CONFIG}, and it is independent from the coherent bandwidth of the experienced channel profile at the apparatus 300). Furthermore, the apparatus 300 only detects the TDD configuration within the time window T_{TDD}_{_{—}}_{CONFIG}, which reduces its power consumption.

At step 210, the apparatus 300 sends an acknowledgement to the radio network node 400 in response to determining 208, 209 the time division duplex uplink/downlink configuration to be used. Optionally, the acknowledgement may include a bit to be sent via a physical uplink control channel by triggering a scheduling request on configured physical uplink control channel resources. Optionally, scheduling request transmission periodicity and scheduling request subframe offset may be aligned with an uplink/downlink configuration change periodicity. Optionally, the scheduling request may be appended at the end of a sequence of concatenated hybrid automatic repeat request acknowledgement information bits in response to the transmission of the scheduling request coinciding in time with transmission of hybrid automatic repeat request acknowledgement feedback using physical uplink control channel format 3. Optionally, physical uplink control channel format 1 may be utilized in transmitting the scheduling request. Optionally, at least one of the uplink/downlink configuration indications may include a component carrier applicability indication.

In other words, the acknowledgement mechanism for TDD configuration signaling is used to further reduce errors. The radio network node 400 may configure PUCCH (physical uplink control channel) resources via higher layer signaling for the UE 300 in RRC_CONNECTED state to allow Scheduling Request (SR) for normal operations, and new TDD configuration acknowledgement as a re-interpreted SR. Upon receiving the new TDD configuration, the apparatus 300 may send the new TDD configuration acknowledgement as one-bit via PUCCH by triggering a Scheduling Request on the configured PUCCH resources. The radio network node 400 reinterpretes the SR received via PUCCH from the apparatus 300 as being the one-bit new TDD configuration acknowledgement. To allow efficient signaling, the UE-specific SR periodicity (SR_{PERIODICITY}) and subframe offset (N_{OFFSET,SR}) configuration via parameter sr-ConfigIndex I_{SR} (described in more detail e.g. in 3GPP specification TS36.213 “Physical layer procedures”, v10.0.0, December 2010) are aligned with the TDD configuration change periodicity, and thus allow sufficient spare PUCCH resources for the normal SR. The alignment of the SR parameters with the TDD configuration allows both the radio network node 400 and the apparatus 300 to implicitly know how to differentiate between PUCCH resource for the new TDD configuration or for the normal SR. If the transmission of scheduling request coincides in time with the transmission of HARQ-ACK feedback using PUCCH format 3, the scheduling request may be appended at the end of a sequence of concatenated HARQ-ACK information bits (described in more detail e.g. in 3GPP specification TS36.221 “MAC layer Procedures”, v10.0.0, December 2010). Otherwise PUCCH format 1 may be used.

An advantage of the above acknowledgment procedure via PUCCH and re-interpreted SR for the TDD configuration is that it allows further avoiding errors impacting CRS-based measurements and handover mechanisms.

FIG. 3 is a block diagram illustrating the apparatus 300 according to an embodiment of the invention. The apparatus 300 may include e.g. a mobile device or a handset or a user equipment (UE) of a mobile communications network. Alternatively, the apparatus 300 may include e.g. a chipset deployed in a mobile device or a handset or a user equipment of a mobile communications network.

The apparatus 300 includes a monitoring unit 310 that is configured to monitor received downlink time division duplex subframes of wireless data transmission during a predetermined time window, at least a portion of the subframes including an uplink/downlink configuration indication. The apparatus 300 further includes an averaging unit 320 that is configured to calculate an average of the monitored uplink/downlink configuration indications in response to not detecting an uplink/downlink configuration indicated by any of the uplink/downlink configuration indications in the monitored downlink time division duplex subframes. The apparatus 300 further includes a time division duplex uplink/downlink configuration determination unit 330 that is configured to utilize the calculated average in determining a time division duplex uplink/downlink configuration to be used.

The apparatus 300 may further include a monitoring stop unit 340 that is configured to stop the monitoring unit 310 from monitoring, in response to an uplink/downlink configuration indicated by an uplink/downlink configuration indication being detected in a monitored downlink time division duplex subframe, for subsequent subframes in the remaining time window. In this case the time division duplex uplink/downlink configuration determination unit 330 is further configured to utilize the detected uplink/downlink configuration in determining the time division duplex uplink/downlink configuration to be used.

The apparatus 300 may further include a time window obtainer 350 that is configured to obtain information about the predetermined time window from a received indication of the predetermined time window. The apparatus 300 may further include an acknowledgement unit 360 that is configured to send an acknowledgement to a sender of the uplink/downlink configuration indications in response to the time division duplex uplink/downlink configuration determination unit 330 determining the time division duplex uplink/downlink configuration to be used.

The above described elements 310-360 of the apparatus 300 may be implemented with software or hardware, or a combination of both.

As is known in the art, in LTE TDD systems, many operations at both evolved Node B (eNB) and user equipment (UE) sides depend on the semi-static TDD configuration. These operations include e.g. radio resource management (RRM) measurements, channel quality information (CQI) measurements, channel estimations, physical downlink control channel (PDCCH) detections, and hybrid automatic repeat request (HARQ) timings.

The UE firstly needs to read the system information to find out the TDD UL/DL configuration in its current cell. Then it knows which subframe to monitor for measurement, for CQI measure and report, for time domain filtering to get channel estimation, for PDCCH detection, or for DL/UL ACK/NACK feedback.

Therefore, in an embodiment of the invention, TDD configurations in accordance with 3GPP specifications are used. Further, operations based on semi-static TDD configurations may be kept unchanged, e.g. by a higher frequency of change of the dynamical TDD configuration.

Since all UEs need to get the new TDD configuration, in an embodiment common search space is used to carry the TDD configuration signalling due to: no need to align starting position of UE-specific search spaces, and to simplify the TDD repetition detection algorithms in the apparatus 300 as there's no CCE interleaving on the common search space. Alternatively, a search space specific to the apparatus 300 may be used for the TDD configuration signaling with a starting position aligned via higher-layer signaling for all the UEs.

Furthermore, assuming carrier aggregation is used, the TDD configuration signaling S_{TDD}_{_{—}}_{CONFIG} may be extended with a Carrier Indicator Flag (CIF) or with another suitable way to indicate whether a new TDD configuration applies to the PCell CC (Primary Cell Component Carrier) or the SCell CC (Secondary Cell Component Carrier), or both CCs.

The exemplary embodiments can include, for example, any suitable servers, workstations, PCs, laptop computers, personal digital assistants (PDAs), Internet appliances, handheld devices, cellular telephones, smart phones, wireless devices, other devices, and the like, capable of performing the processes of the exemplary embodiments. The devices and subsystems of the exemplary embodiments can communicate with each other using any suitable protocol and can be implemented using one or more programmed computer systems or devices.

One or more interface mechanisms can be used with the exemplary embodiments, including, for example, Internet access, telecommunications in any suitable form (e.g., voice, modem, and the like), wireless communications media, and the like. For example, employed communications networks or links can include one or more wireless communications networks, cellular communications networks, 3G communications networks, Public Switched Telephone Network (PSTNs), Packet Data Networks (PDNs), the Internet, intranets, a combination thereof, and the like.

It is to be understood that the exemplary embodiments are for exemplary purposes, as many variations of the specific hardware used to implement the exemplary embodiments are possible, as will be appreciated by those skilled in the hardware and/or software art(s). For example, the functionality of one or more of the components of the exemplary embodiments can be implemented via one or more hardware and/or software devices.

The exemplary embodiments can store information relating to various processes described herein. This information can be stored in one or more memories, such as a hard disk, optical disk, magneto-optical disk, RAM, and the like. One or more databases can store the information used to implement the exemplary embodiments of the present inventions. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases.

All or a portion of the exemplary embodiments can be conveniently implemented using one or more general purpose processors, microprocessors, digital signal processors, micro-controllers, and the like, programmed according to the teachings of the exemplary embodiments of the present inventions, as will be appreciated by those skilled in the computer and/or software art(s). Appropriate software can be readily prepared by programmers of ordinary skill based on the teachings of the exemplary embodiments, as will be appreciated by those skilled in the software art. In addition, the exemplary embodiments can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware and/or software.

Stored on any one or on a combination of computer readable media, the exemplary embodiments of the present inventions can include software for controlling the components of the exemplary embodiments, for driving the components of the exemplary embodiments, for enabling the components of the exemplary embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the exemplary embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present inventions can be distributed for better performance, reliability, cost, and the like.

As stated above, the components of the exemplary embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magnetooptical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CD±R, CD±RW, DVD, DVDRAM, DVD±RW, DVD±R, HD DVD, HD DVD-R, HD DVD-RW, HD DVD-RAM, Blu-ray Disc, any other suitable optical medium, punch cards, paper tape, optical mark sheets, any other suitable physical medium with patterns of holes or other optically recognizable indicia, a RAM, a PROM, an EPROM, a FLASHEPROM, any other suitable memory chip or cartridge, a carrier wave or any other suitable medium from which a computer can read.

While the present inventions have been described in connection with a number of exemplary embodiments, and implementations, the present inventions are not so limited, but rather cover various modifications, and equivalent arrangements, which fall within the purview of prospective claims.

What is claimed is:

1. A method, comprising:
monitoring received downlink time division duplex subframes of wireless data transmission during a predetermined time window, at least a portion of the subframes including an uplink/downlink configuration indication;
in response to not detecting an uplink/downlink configuration indicated by any of the uplink/downlink configuration indications in the monitored downlink time division duplex subframes, calculating an average of the monitored uplink/downlink configuration indications; and
utilizing the calculated average in determining a time division duplex uplink/downlink configuration to be used.

2. The method according to claim 1, further comprising:
in response to detecting an uplink/downlink configuration indicated by an uplink/downlink configuration indication in a monitored downlink time division duplex subframe, stopping the monitoring for subsequent subframes in the remaining time window; and
utilizing the detected uplink/downlink configuration in determining a time division duplex uplink/downlink configuration to be used.

3. The method according to claim 1, wherein the received subframes comprise fixed subframes.

4. The method according to claim 1, further comprising obtaining information about the predetermined time window from a received indication of the predetermined time window.

5. The method according to claim 1, further comprising:
in response to determining the time division duplex uplink/downlink configuration to be used, sending an acknowledgement to a sender of the uplink/downlink configuration indications.

6. The method according to claim 5, wherein the acknowledgement comprises a bit to be sent via a physical uplink control channel by triggering a scheduling request on configured physical uplink control channel resources.

7. The method according to claim 6, further comprising aligning scheduling request transmission periodicity and scheduling request subframe offset with an uplink/downlink configuration change periodicity.

8. The method according to claim 6, further comprising appending the scheduling request at the end of a sequence of concatenated hybrid automatic repeat request acknowledgement information bits in response to the transmission of the scheduling request coinciding in time with transmission of hybrid automatic repeat request acknowledgement feedback using physical uplink control channel format 3.

9. The method according to claim 6, further comprising utilizing physical uplink control channel format 1 in transmitting the scheduling request.

10. The method according to claim 1, wherein at least one of the uplink/downlink configuration indications comprises a component carrier applicability indication.

11. An apparatus, comprising:
a monitoring unit configured to monitor received downlink time division duplex subframes of wireless data transmission during a predetermined time window, at least a portion of the subframes including an uplink/downlink configuration indication;
an averaging unit configured to calculate an average of the monitored uplink/downlink configuration indications in response to not detecting an uplink/downlink configuration indicated by any of the uplink/downlink configuration indications in the monitored downlink time division duplex subframes; and
a time division duplex uplink/downlink configuration determination unit configured to utilize the calculated average in determining a time division duplex uplink/downlink configuration to be used.

12. The apparatus according to claim 11, further comprising:
a monitoring stop unit configured to stop the monitoring unit from monitoring, in response to an uplink/downlink configuration indicated by an uplink/downlink configuration indication being detected in a monitored down-link time division duplex subframe, for subsequent subframes in the remaining time window;
wherein the time division duplex uplink/downlink configuration determination unit is further configured to utilize the detected uplink/downlink configuration in determining the time division duplex uplink/downlink configuration to be used.

13. The apparatus according to claim 11, wherein the received subframes comprise fixed subframes.

14. The apparatus according to claim 11, further comprising time window obtainer configured to obtain information about the predetermined time window from a received indication of the predetermined time window.

15. The apparatus according to claim 11, further comprising:
an acknowledgement unit configured to send an acknowledgement to a sender of the uplink/downlink configuration indications in response to the time division duplex uplink/downlink configuration determination unit determining the time division duplex uplink/downlink configuration to be used.

16. The apparatus according to claim 15, wherein the acknowledgement comprises a bit to be sent via a physical uplink control channel by triggering a scheduling request on configured physical uplink control channel resources.

17. The apparatus according to claim 16, wherein the acknowledgement unit is further configured to align scheduling request transmission periodicity and scheduling request subframe offset with an uplink/downlink configuration change periodicity.

18. The apparatus according to claim 16, wherein the acknowledgement unit is further configured to append the scheduling request at the end of a sequence of concatenated hybrid automatic repeat request acknowledgement information bits in response to the transmission of the scheduling request coinciding in time with transmission of hybrid automatic repeat request acknowledgement feedback using physical uplink control channel format 3.

19. The apparatus according to claim 16, wherein the acknowledgement unit is further configured to utilize physical uplink control channel format 1 in transmitting the scheduling request.

20. The apparatus according to claim 11, wherein at least one of the uplink/downlink configuration indications comprises a component carrier applicability indication.

21. A non-transitory computer-readable storage medium comprising computer program code which when executed by a data processing system, causes the data-processing system to:
monitor received downlink time division duplex subframes of wireless data transmission during a predetermined time window, at least a portion of the subframes including an uplink/downlink configuration indication;
in response to not detecting an uplink/downlink configuration indicated by any of the uplink/downlink configuration indications in the monitored downlink time division duplex subframes, calculate an average of the monitored uplink/downlink configuration indications; and
utilize the calculated average in determining a time division duplex uplink/downlink configuration to be used.
